(19) United States
(12) Patent Application Publication
(10) Pub. No.: US 2009/0052604 A1
(43) Pub. Date: Feb. 26, 2009

(54) Temperature Detection Apparatus For Natural Circulation Boiling Water Reactor

(76) Inventors: Yoshihiko Ishii, Hitachinaka (JP); Shiro Takahashi, Hitachi (JP); Setsuo Arita, Hitachiota (JP); Atsushi Fushimi, Hitachi (JP); Tomohiko Ikegawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/250,762

(22) Filed: Oct. 14, 2008

Related U.S. Application Data
(63) Continuation of application No. 11/678,740, filed on Feb. 26, 2007.

(30) Foreign Application Priority Data
Feb. 27, 2006 (JP) 2006-050917

(51) Int. Cl. G21C 17/112

(52) U.S. Cl. 376/247

(57) ABSTRACT

A natural circulation boiling water reactor includes a reactor pressure vessel, a chimney including a lattice member and arranged above a core in the reactor pressure vessel, and at least one thermocouple extension wire pulling conduit into which a temperature detection thermocouple and a cable connected to said temperature detection thermocouple are inserted. The thermocouple extension wire pulling conduit is disposed on an upper end surface of the lattice member and mounted to the upper end surface of the lattice member.

### CLAIM OF PRIORITY

This application is a continuation of U.S. application Ser. No. 11/678,740, filed Feb. 26, 2007, the contents of which are incorporated herein by reference.

The present application claims priority from Japanese application serial no. 2006-050917, filed on Feb. 27, 2006, the content of which is hereby incorporated by reference into this application.

### BACKGROUND OF THE INVENTION

The present invention relates to a temperature detector for a natural circulation boiling water reactor in which coolant is circulated by natural circulation.

In the natural circulation boiling water reactor (simply referred to as “natural circulation reactor” hereinafter) a chimney is provided at an upper end of a core shroud which encloses a core. The mixture flow (two-phase flow) of cooling water and steam (bubbles, also called voids) ascends in the core and the chimney. The cooling water being supplied to the reactor pressure vessel from the feed water pipe and the cooling water that flows out from the chimney are mixed in a circular flow path called downcomer, which is formed between the outer surface of the core shroud and the reactor pressure vessel. The mixed flow descends in the downcomer. Thus, the cooling water circulates inside and outside the core shroud. The natural circulation reactor does not have any forced circulation devices such as a recirculation pump or the like, and the density difference between the density of the two-phase flow inside the core shroud and the density of the cooling water outside the shroud causes the circulation flow.

When the natural circulation reactor is started up from the low pressure sub-critical state, control rods are withdrawn from the core, and the reactor becomes critical state. This process is called as a critical control process. Then reactor power is controlled to a few percent of a rated thermal power by the control rod operation and temperature and pressure of the reactor are at last reached the rated ones. This process is called as a heat-up control process.

Subsequently, in the state that the reactor pressure is kept to be constant, the control rods are withdrawn from the core. As a result, the reactor condition changes from a high pressure, low power state to a high pressure, high power state. It is known that an instability phenomenon called natural circulation instability may occur at the beginning of the heat-up control process during a low pressure, low power state to the high pressure, low power state.

First, the principle of the instability phenomenon in this state will be described. If the boiling starting position of the coolant in the chimney moves to the upstream for some reasons, the amount of the steam in the chimney increases (void fraction increases), and the density of the mixed flow in the chimney is lightened. Thus, the density difference between the core shroud inside and the downcomer increases, and the cooling water flow rate being supplied into the core increases too. When this occurs, the core is more cooled than before and the cooling water temperature decreases at the core outlet. The boiling starting position in the chimney moves to downstream and the amount of generated steam decreases. Thus, the void fraction decreases. As a result, the density difference between the density of the core shroud inside and the downcomer becomes smaller and the cooling water flow rate being supplied into the core decreases.

When this core cooling water flow decreases, the cooling water temperature at the core exit becomes higher and the boiling starting position in the chimney moves to the upstream and the void fraction increases. The density difference between the core shroud inside and the downcomer increases and the cooling water flow rate supplied to the core increases. At low pressure, the density difference between the steam and the cooling water is larger compared to that of high pressure. For example, at 1 atmospheric pressure, the density ratio of water and steam is approximately 1000:1, while at 70 atmospheric pressures, the density ratio is about 20:1. As a result, at low pressure, the change of the natural circulation force due to the void fraction change inside the chimney becomes large. This phenomenon is called natural circulation instability. In this manner, in the heat-up control process of the natural circulation reactor, the boiling starting position in the chimney undulates up and down and the natural circulation instability may occur, in which the core flow rate undulates.

In addition, at the beginning of the start-up control process, because the reactor power is low and the absolute value of the natural circulation flow rate is smaller than that of high pressure, the amplitude of the flow variation becomes relatively larger. Even though the flow instability occurs, fuel rods are not damaged because the reactor power is very low at the heat-up control process. However, the temperature of the cooling water in the core may vary due to the flow variation and that causes nuclear reactivity changes. It may cause the short signal of reactor period which indicates sudden increase in neutron flux. If this signal is detected, the operation of withdrawing control rods cannot be permitted.

A known method for preventing this flow instability is, for example, the technique in Japanese Patent Laid-open No. Sho 59(1984)-143997 of utilizing the heat of boiler used for periodic inspection. At first, the reactor water temperature and pressure are increased by the boiler heat and the high pressure state in which the instability is unlikely to occur is obtained, and next the reactor power is increased. In Japanese Patent Laid-open No. Hei 5(1993)-72387, a method is disclosed in which a pressurizing device is introduced and the natural circulation reactor is started up from the high pressure state in which the instability is unlikely to occur. In both cases the technique is used of increasing power after obtaining high pressure state in which the instability is unlikely to occur. However, in the former case, a large capacity boiler must be provided in order to perform start-up in a short time, while in the latter case a pressurizing device for start-up must be separately provided and this increases construction costs.

Furthermore, Japanese Patent Laid-open No. Hei 8(1996)-94793 describes the technique that the upper portion of the core and lower portion of the chimney are equipped with pressure gauges and thermometers and the saturation temperatures of the upper portion of the core and lower portion of the chimney are calculated from measured pressures and when the core outlet is in saturated condition and the lower portion of the chimney is in the sub-cooling condition, the reactor pressure is forced to reduce or the reactor power is done to increase, and the entire region of the chimney reaches a saturated state and stability is improved. This is based on the knowledge that flow stability is improved if the entire regions in the core and the chimney are in the two-phase flow condition even at low pressure, but when actual start-up is considered, starting up at a high power that makes entire regions of the core and chimney a saturated state is difficult at the beginning of the heat-up control process. In addition, reducing the reactor pressure while reactor pressure is increasing causes start-up time elongation.

### SUMMARY OF THE INVENTION

The methods for measuring the temperatures inside the reactor pressure vessel include the method in the invention described in Japanese Patent Laid-open No. Hei 8(1996)-94793 in which pressure gauges and thermometers respectively are disposed at the upper portion of the core and lower portion of the chimney, but it is extremely difficult to replace the thermometer when it malfunctions (or is damaged). That is to say, in these structures, if the chimney is not removed from the reactor pressure vessel, replacement of the instrumentation pipe which has a built-in thermometers or signal cables and is disposed at the lower portion of the chimney or upper portion of the core, is not possible. The replacement operation of measuring devices is performed when the fuel assemblies are replaced, or at the time of periodic inspection. But if the replacement operation of the instrumentation pipe can be performed without detaching the chimney from the core shroud, the operation rate as well as economic efficiency of the reactor will be improved.

An object of the present invention is to provide a temperature detection apparatus for boiling water reactor in which replacement of the thermometer inside the reactor pressure vessel is easy when it was damaged or at the time of periodic replacement.

The present invention for attaining the above object is characterized by comprising the chimney having lattices and arranged in the reactor pressure vessel, a temperature detection apparatus for a natural circulation boiling water reactor, in which the replacement of the fuel assemblies is possible between the chimney lattices, and a thermocouple extension wire pulling conduit mounted to the upper end of the chimney lattices. The temperature detection apparatus includes a temperature detection thermocouple and a cable connected to the thermocouple. The thermocouple and the cable are inserted into the thermocouple extension wire pulling conduit.

In another preferable embodiment of the present invention, the thermocouple extension wire pulling conduit is mounted to the upper end portion of the chimney lattice. In another preferable embodiment, the thermocouple and a thermocouple extension wire pulling conduit which have the cable connected to the thermocouple are disposed on the vertical line which is the intersection line of the chimney lattices such that the temperature detection thermocouple is disposed at a suitably selected position on the intersection line of the chimney partition. In this case, the lower end of the chimney portion of the thermocouple extension wire pulling conduit is connected to the neutron instrumentation pipe assembly for neutron flux measurement that is disposed inside the core provided under the chimney lattices.

According to the natural circulation reactor of the present invention, the temperature detection apparatus (for example thermocouple) and the extension wire pulling conduit do not become obstacles at the time of replacement of the fuel assemblies, and replacement of a damaged temperature detection apparatus can be performed relatively easily without detaching the chimney.

### BRIEF DESCRIPTION OF THE DRAWINGS

FIG. 1 is a pattern diagram showing the overall structure of an embodiment of the reactor system including the natural circulation reactor used in the present invention.

FIG. 2 is a diagram for explaining circulation of the cooling water in this embodiment of the present invention.

FIG. 3 is a cross sectional view taken along a line A-A of FIG. 1.

FIG. 4 is a perspective view showing an example in which the thermocouple extension wire pulling conduit used in the first embodiment of the present invention is mounted on the upper end of the chimney partition.

FIG. 5 is a perspective view showing the step for drawing the fuel assembly from the chimney in the example in which a plurality of thermocouple extension wire pulling conduits used in the first embodiment of the present invention are mounted on the upper end of the chimney partition.

FIG. 6 is a perspective view showing the arrangement of a plurality of the thermocouple extension wire pulling conduits that is a modified example of the first embodiment of the present invention.

FIG. 7 is a cross sectional view taken along a line A-A of FIG. 1 for explaining the second embodiment of the present invention.

FIG. 8 is an enlarged view of region X in FIG. 7.

FIG. 9 is a longitudinal sectional view showing the intersection portion of the chimney partition in which the thermocouple extension wire pulling conduits are disposed.

FIG. 10 is a longitudinal sectional view showing the case where the thermocouple extension wire pulling conduit and the neutron instrumentation pipe assembly are joined in the second embodiment of the present invention.

### DESCRIPTION OF THE PREFERRED EMBODIMENT

The following is a description of an embodiment of the temperature detection apparatus of the natural circulation reactor of the present invention based on the drawings, but prior to that, a general outline of the reactor power control system of the natural circulation reactor using the temperature detection apparatus of this embodiment will be described.

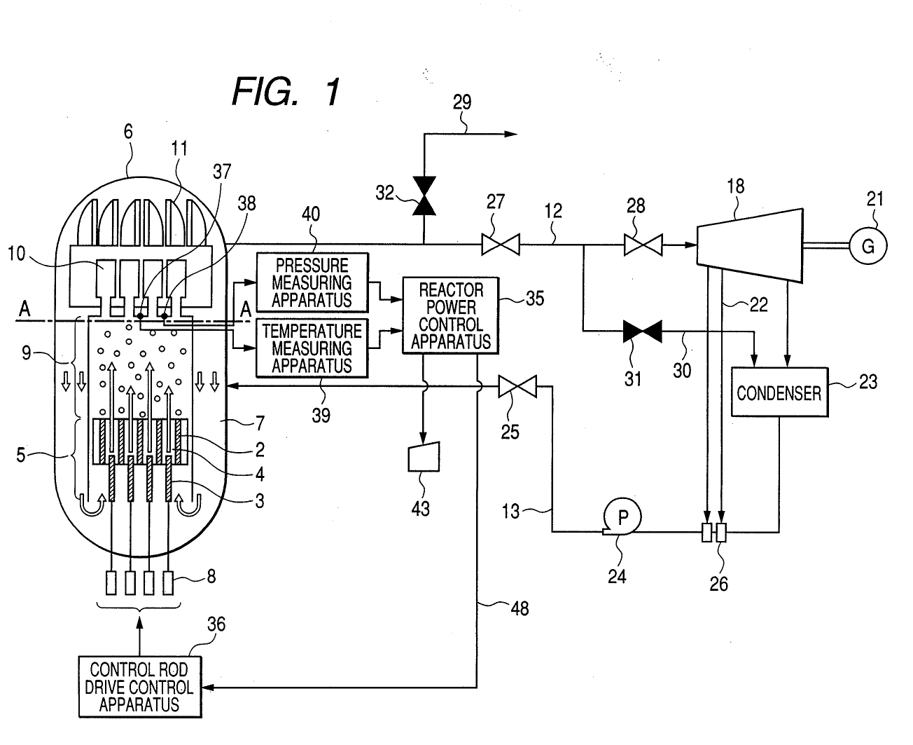

FIG. 1 shows the overall structure of the natural circulation reactor system used in this embodiment.

As shown in FIG. 1, the reactor included in the natural circulation reactor system comprises a plurality of fuel assemblies 2 in which a plurality of fuel rods are aligned, and a core 4 disposing control rods 3 inserted between the fuel assemblies 2.

Also, the lower portion of the reactor pressure vessel 6 is equipped with a control rod drive mechanism 8 which drives the control rods 3 so as to be inserted in the core 4 in the vertical direction. A main steam pipe 12 and a feed water pipe 13 are connected to the reactor pressure vessel 6. Though it doesn't show in the figure, there is some plants with two or more main steam pipes and feed water pipes according to the power scale. A cylindrical core shroud 5 is disposed so as to enclose the core 4 in the reactor pressure vessel 6. Ascending paths in which the coolant (cooling water) ascends in the direction of the arrow in the drawing is formed inside of the core shroud 5. Downcomer 7 that is a descending path in which the coolant descends is formed in the space between the core shroud 5 and the reactor pressure vessel 6. The cylindrical chimney 9 is disposed at the upper portion of the core shroud 5 and a steam separator 10 and a steam dryer 11 are provided at the upper side of the chimney 9.

The coolant of two-phase flow including gas and liquid that is boiled in the core 4 passes through the inside of the chimney 9. The coolant descends the downcomer 7 due to the density difference between the two-phase flow in the shroud 5 and liquid flow passing through the downcomer 7. The coolant in the downcomer 7 is introduced to the core 4 and ascends in the chimney 9. A circulation path having the ascending path formed in the core 4 and the chimney 7 and the descending path formed in the downcomer 7 is formed in the reactor pressure vessel 6. When the mixture of cooling water and steam that ascends in the chimney 9 passes through the steam separator 10, the steam is separated from the mixture by the steam separator 10. The cooling water separated at the steam separator 10 descends down the downcomer 7 and passes the lower portion of the reactor pressure vessel 6 and is supplied into the core 4 inside the core shroud 5.

In the steam dryer 11, the tiny water droplets are removed from the steam that came from the steam separator 10. Then the steam is supplied to the turbine 18 via the main steam pipe 12. The turbine 18 and the generator 21 connected thereto are rotated by this steam flow and power is generated.

The steam that rotated the turbine 18 is led to the condenser 23 and becomes condensed water. The condensed water is returned to the reactor pressure vessel 6 through a feed water pipe 13 by the feed water pump 24. The feed water pipe 13 has a flow rate adjusting valve 25. By adjusting the feed water flow rate by the flow rate adjusting valve 25, the reactor water level in the reactor pressure vessel 6 can be controlled. The feed water pipe 13 also has feed water heaters 26. The steam extracted at a middle stage in the turbine 18 is introduced to the feed water heater 26 via the extraction pipe 22. At the feed water heater 26, the cooling water introduced from the condenser 23 is heated to a suitable temperature and injected into the reactor pressure vessel 6.

The main steam pipe 12 has a main steam isolation valve 27 and a steam flow adjusting valve 28 which adjusts the amount of steam that is introduced into the turbine 18. A relief pipe 29 having a safety valve and a bypass pipe 30 having a turbine bypass valve 31 are connected to the main steam pipe 12. When the turbine steam flow adjusting valve 28 is closed, the turbine bypass valve 31 is opened. Thus, some steam is directly introduced into the condenser 23 via the bypass pipe 30 without any of the steam being introduced into the turbine 18. When the main steam isolation valve 27 is closed, the safety valve 32 is opened. As a result, the steam generated in the reactor pressure vessel 6 is led into a pressure suppression pool (not shown) in the containment vessel and the steam is condensed in the pressure suppression pool.

In this embodiment of the present invention, the upper portion of the chimney 9 in the reactor pressure vessel 6 has a temperature detection section (temperature detection apparatus) 37 of the gas-liquid mixed flow and a pressure detection section 38 to measure the pressure of the liquid. The temperature and pressure signals that are detected here are transferred to the temperature measuring apparatus 39 and the pressure measuring apparatus 40 respectively. The temperature measuring apparatus 39 and the pressure measuring apparatus 40 convert the electrical signals to actual temperature and pressure units and output the converted electrical signals to the reactor power control apparatus 35. The reactor power control apparatus 35 incorporates an controller to control the reactor power not to occur the natural circulation instability by using the temperature detection section 37. The reactor power control apparatus 35 generates control rod operation signals to realize stable reactor operation and outputs the signals to the control rod drive control apparatus 36. The control rod drive control apparatus 36 controls the control rod drive mechanism 8 having an electric motor or a hydraulic piston which drives the control rods 3.

A display apparatus 43 is also connected to the reactor power control apparatus 35. This display apparatus 43 displays information relating to coolant temperature of the chimney 9 and the stable boundary temperature at which the flow instability will occur, on the same screen. Thus, the reactor operator can look at this display screen and confirm the stability of the operation state of the reactor. The temperature of the coolant in the chimney 9 is an important information to keep the flow state in the reactor pressure vessel 6 stable at the start-up operation.

Prior to describing an example of an embodiment of this temperature detection apparatus of the present invention, the coolant flow of the reactor pressure vessel 6 and the temperature in this embodiment will be described.

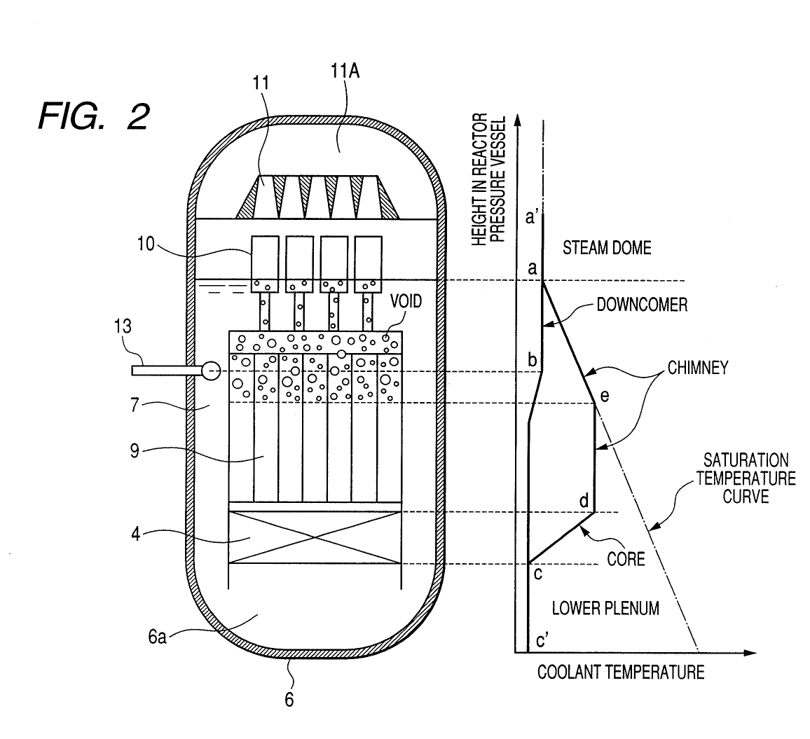

FIG. 2 shows an example of the inside structure of the reactor pressure vessel 6 and the temperature distribution of the cooling water at the beginning of the heat-up control process. When the pressure in the steam dome 11A is 1 atmospheric pressure for example, the temperature of the steam and the cooling water in the vicinity of water surface in the steam dome 11a is the saturated temperature which is about 100° C. The cooling water which descends in the downcomer 7 (b portion at the right of FIG. 2) is mixed with the cooling water (feed water) being supplied from the feed water pipe 13 or a coolant purification system pipe connected to the reactor pressure vessel 6. When the cooling water mixed with the feed water arrives at the lower plenum 6a in the reactor pressure vessel 6, the temperature of the cooling water decreases (for example to 95° C.) at c-c′ at the right of FIG. 2. The downcomer 7 and the lower plenum 6a has a higher pressure than that of the steam dome 11a due to the static head. At a position of 10 m below the steam dome 11a, the pressure at that position is approximately 2 atmospheric pressures. Static head herein means increase in pressure due to the dead weight of water, which is expressed in the equation of (density)×(water height)×(gravity acceleration)≈1 atmospheric pressure, where water density of 1 g/cm³ and water height of 10 m.

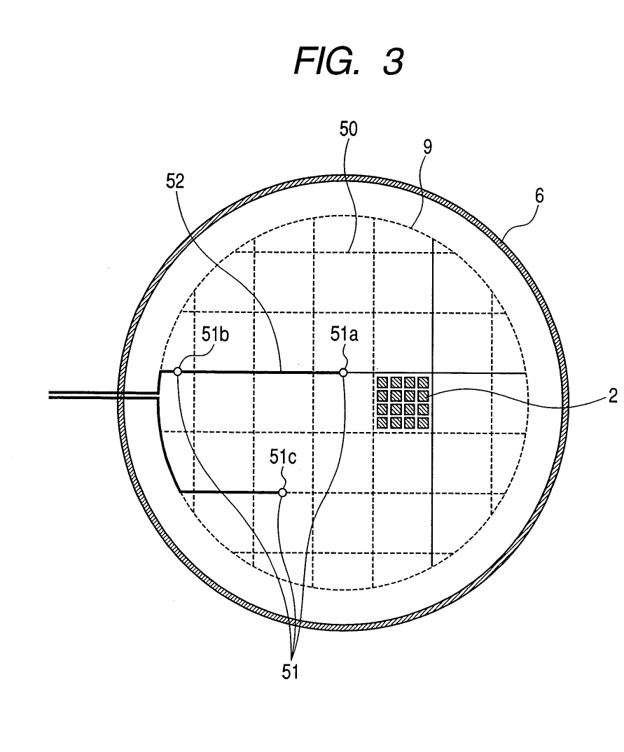

The saturation temperature of 2 atmospheric pressures is approximately 120° C., and sub-cooling temperature of cooling water (difference between the saturation temperature and the cooling water temperature) at 95° C. is 25° C. The cooling water supplied to the core 4 from the lower plenum 6a is warmed at the core 4 (c-d at the right of FIG. 3). For example, in FIG. 2, if the temperature is increased to 110° C., when the saturation temperature at the outlet of the core 4 is higher than 110° C., boiling does not occur at the outlet of the core 4. Subsequently, when the static head decrease as the cooling water ascends in the chimney 9 (d-e at the right of FIG. 2), the pressure drops and the saturation temperature is decreased. When the cooling water of 110° C. reaches to the position where the saturation temperature of the cooling water becomes 110° C., boiling of the cooling water begins and steam is generated from the cooling water to become a mixed flow (e-a at the right of FIG. 3). When this cooling water ascends further up in the chimney 9, the saturation temperature of the cooling water also decreases due to the decrease in pressure and thus the cooling water temperature decreases (e-a at the right of FIG. 2). In the region over the water surface, steam temperature remains almost constant (a-a′ at the right of FIG. 2).

At the beginning of the heat-up control process at the low pressure and low rector power state, the natural circulation instability may occur due to the boiling starting position movement in the chimney 9. The saturation temperature at which boiling begins can be easily obtained using a steam-water property chart based on the pressure, therefore, if the cooling water temperature and pressure at the upper end of the chimney 9 are measured, it is possible to determine that the boiling is occurring at the chimney upper end. If periodic temperature change is observed in the chimney upper end, it can be confirmed that the natural circulation instability occurs. If there is little or no boiling at the chimney upper end at start-up, a stable flow state is obtained. Thus, if the temperature at the outlet of the chimney 9 is measured, generation of natural circulation instability can be confirmed and the reactor power can be controlled so as to prevent instability generation. It is to be noted that there is a temperature distribution with respect to the radial direction position due to the power difference between the fuel assemblies 2 in the core outlet in the core shroud 5. One portion of the chimney 9 divided by partitions usually corresponds to a plurality of the fuel assemblies. At the lower end of the chimney 9, the coolants with different temperatures exhausted from the each fuel assembly 2 are in a state of beginning of mixing, thus there are large temperature variations according to the temperature measurement position in the horizontal plane. Meanwhile, at the upper end of the chimney 9, mixing of the coolants with different temperatures has developed and variations in the coolant temperature due to temperature measurement position and time become less. Thus, in the case where the temperature in the chimney is measured, measurement at the chimney upper portion which has comparatively little cooling water temperature variation is suitable.

Because the fuel assembly 2 must be taken out from the core 4 by using a fuel exchange apparatus (not shown), the position for installation of the temperature detection section 37 and the pressure detection section 38 must be such that they do not become obstacles when the operation of the fuel exchange is performed. That is to say, in the natural circulation reactor, when the operation of periodic exchange of the fuel assemblies 2 is performed, the fuel assembly 2 is usually taken out through the chimney 9 and it is suitable for the temperature detection section 37 and the pressure detection section 38 to be at position where they do not become obstacles at the time of this operation such as at the upper portion of the chimney partition (not shown), or at a position adjacent thereto.

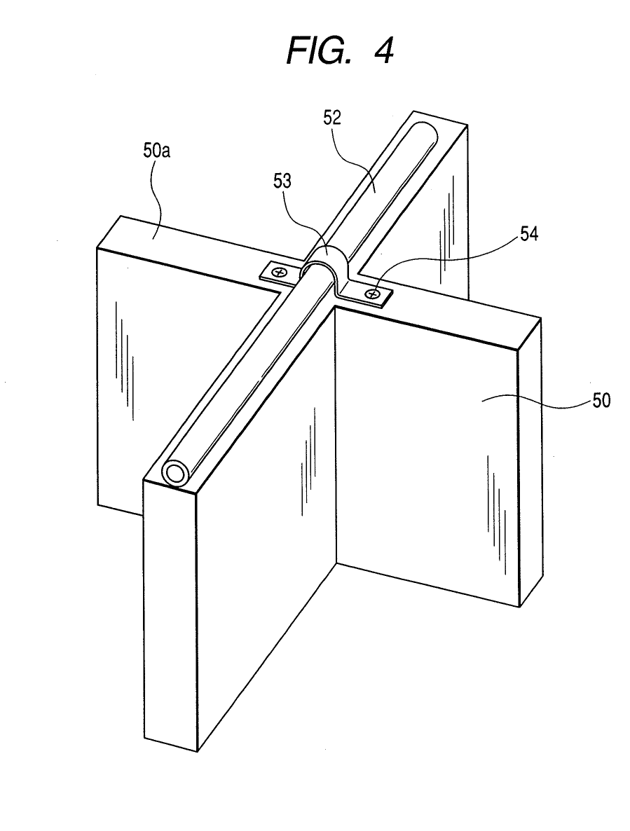

FIG. 3 shows a cross section taken along a line A-A of FIG. 1. The chimney upper portion disposed in the reactor pressure vessel 6 has a lattice structure as shown by the dotted line. This lattice structure forms the chimney partition wall (lattice member) 50 (see FIG. 4) and reaches to the chimney lower portion. The core shroud 5 is placed so as to enclose the core 4 on the chimney lattice lower portion as described above.

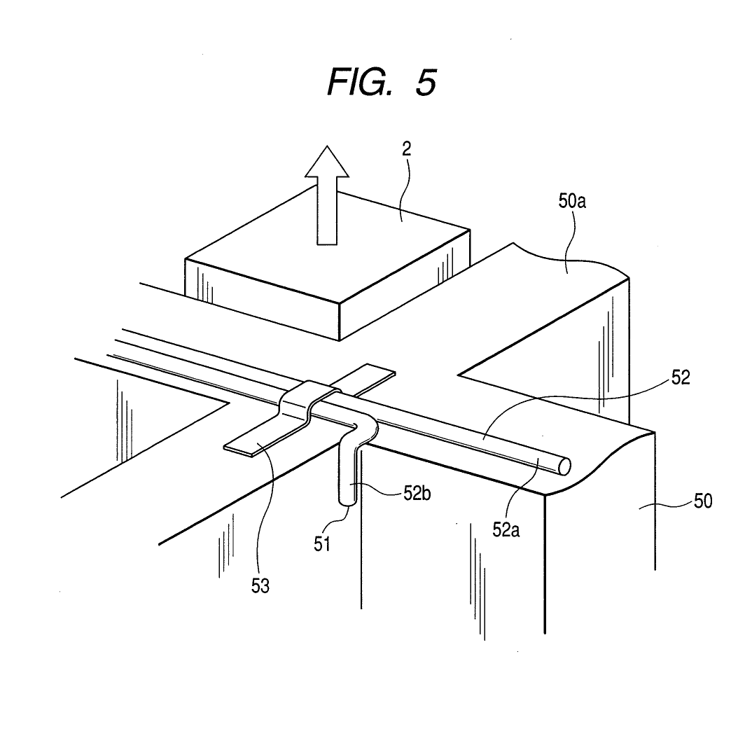

The fuel assemblies 2 are disposed in the core 4 inside the core shroud 5 and under the chimney 9. When viewed from the upper side of the chimney 9, as shown in FIG. 3, the fuel assemblies 2 is disposed at a position between the lattice of the chimney, or in other words under the position enclosed by the chimney lattice wall 50. By positioning the fuel assemblies 2 at the vertical lower portion direction of the space position enclosed by the chimney partition (chimney lattice wall 50), the exchange of the fuel assemblies 2 is possible when the fuel assembly 2 is taken out from the upper side of the chimney 9 without removing the chimney 9 (see FIG. 5).

The thermocouple extension wire pulling conduit 52 for inserting the thermocouples 51a-51c (together called thermocouple 51 hereinafter) which function as the temperature detection section 37 are disposed at the upper portion of the chimney partition wall 50. The plurality of thermocouple extension wire pulling conduits 52 for the thermocouple 51 are usually provided so as to correspond to the number of thermocouples 51. In FIG. 3, three thermocouples 51a, 51b and 51c are disposed, and the thermocouple extension wire pulling conduits 52 for each of these thermocouples 51a-51c are provided.

FIG. 4 shows the mounting structure for mounting the thermocouple extension wire pulling conduit 52 for the thermocouple 51 on the chimney partition upper end 50a. The chimney partition wall 50a is made of stainless steel such as SUS and the like. The thermocouple extension wire pulling conduit 52 is formed of a pipe filled with SUS and a mineral powder such as silica and the like, into which thermocouple 51 and the cable (not shown) attached thereto are inserted. The position of the thermocouple 51 in thermocouple extension wire pulling conduit 52 is at a suitable measurement site. As shown in FIG. 4, the thermocouple extension wire pulling conduit 52 is fixed to the chimney partition wall upper end 50a with fixing pieces such as the bolt 54 and the support bracket 53 or the like.

FIG. 5 shows the position where the fuel assembly 2 passes the chimney 9 when the fuel assembly 2 is exchanged. As is seen from the drawing, the fuel assembly 2 is taken out in the direction shown by the arrow in the drawing through the space portion enclosed by the chimney partition wall 50. As shown in FIG. 4, the upper end of the chimney partition wall 50 is formed as a lattice and a thermocouple extension wire pulling conduit 52 is fixed to the chimney lattice upper end 50a by the support bracket 53.

In the example shown in FIG. 5, the thermocouple extension wire pulling conduit 52 is shown as two extension wire pulling conduits 52a and 52b made by SUS. The front end of the extension wire pulling conduit 52a is disposed at the chimney partition upper end 50a. The thermocouple extension wire pulling conduit 52b is subjected to bending processing at the middle portion thereof and its front end is disposed at a position adjacent to the side wall of the chimney partition wall 50. The temperature detection section (thermocouple) 51 is disposed in the vicinity of the front end of the extension wire pulling conduit 52b and it is also disposed inside the thermocouple extension wire pulling conduit 52a. Detection of temperature both at the upper end surface of the chimney partition wall 50 and the position slightly beneath the upper end of the chimney partition wall 50 becomes possible. Because the thermocouple extension wire pulling conduits 52a and 52b are disposed in this manner, when the fuel assembly 2 is taken out from the upper portion of the chimney 9, the thermocouple extension wire pulling conduit 52 never becomes obstacle for the taking out fuel assembly 2.

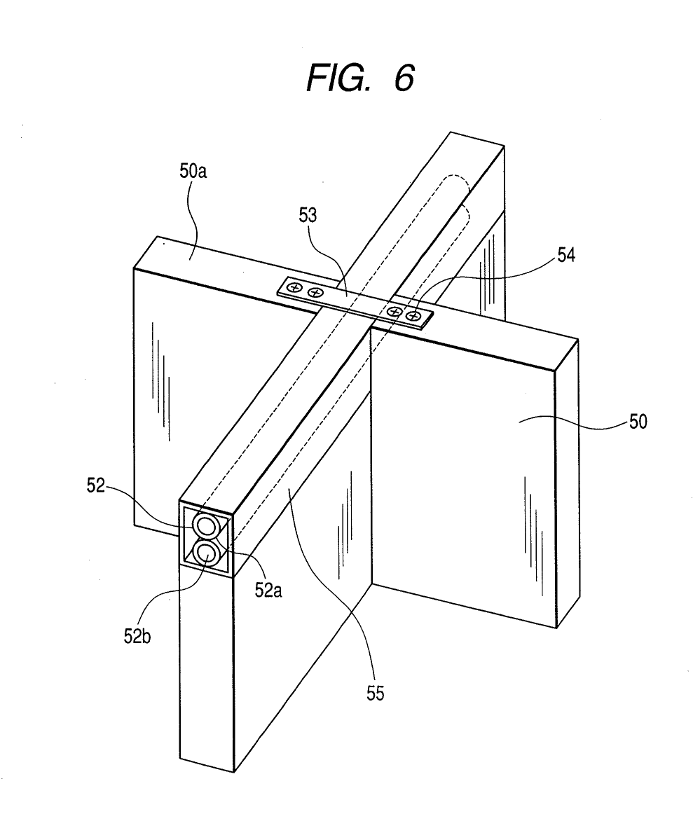

FIG. 6 shows another example of the case where a plurality of thermocouple extension wire pulling conduits 52 are mounted to the upper portion of the chimney partition wall 50. In this example, one chimney partition wall 50 disposed orthogonally is processed so as to be shorter than the other wall 50. A thermocouple extension wire pulling conduit assembly 55 into which the plurality of thermocouple extension wire pulling conduits 52 can be inserted together is provided at the upper end of the chimney partition wall 50 that has been processed so as to be short in vertical direction. Because the thermocouple extension wire pulling conduit assembly 55 is disposed on one upper end of the chimney partition wall 50 processed to be short, an upper end of the thermocouple extension wire pulling conduit assembly 55 is formed so as to have the same height as the other orthogonal chimney partition wall upper end 50a.

By forming the chimney partition wall 50 and the thermocouple extension wire pulling conduit 52 described above, an upper end 50a of the other chimney partition wall 50 and the upper end of the thermocouple extension wire pulling conduit assembly 55 are almost flush and thus there is no need to subject the support bracket 52 to special bending processing, and as shown in the drawing, and the support bracket 52 can be fixed to the upper end 50a of the chimney partition wall 50 using a fixing piece such as a bolt 54 or the like.

In the example shown in FIG. 6, two thermocouple extension wire pulling conduits 52 are provided on the upper portion of the chimney 9. However, more thermocouple extension wire pulling conduits may be provided depending on how many locations on the upper potion of the chimney partition temperature measurement is to be done. For example, as shown in FIG. 6, the plurality of thermocouple extension wire pulling conduits may be provided so as to stack in the vertical direction as well as they may be aligned in the horizontal direction. In the case that measurement is done at four locations, the four thermocouple extension wire pulling conduits may be arranged so that two pulling conduits are side by side and other two pulling conduits stack to form the thermocouple extension wire pulling conduit assembly.

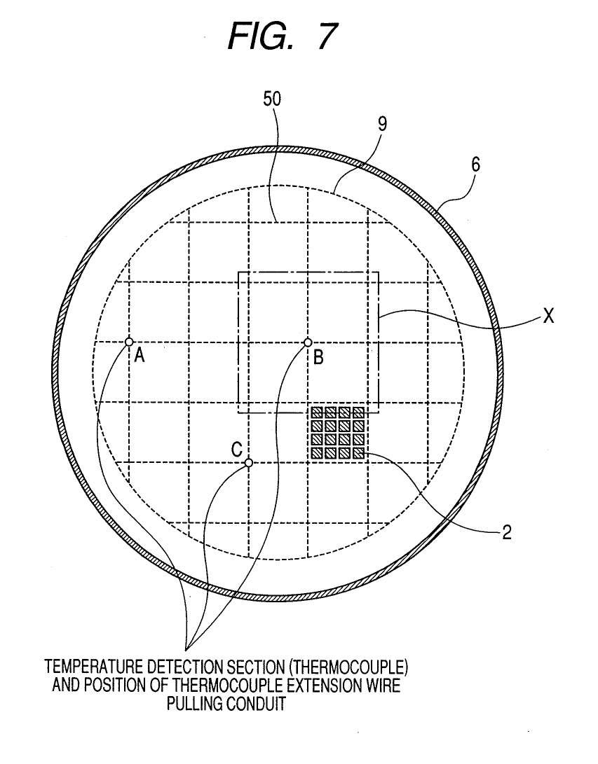

FIG. 7-FIG. 10 show the thermocouple mounting device for the second embodiment of the present invention. FIG. 7 shows a cross section (cross section taken along a line A-A of FIG. 1) of the chimney upper portion, and difference between this and the cross section of FIG. 3 is that the thermocouple extension wire pulling conduit 52 cannot be seen from the upper side as it is in FIG. 3. The thermocouples which are the temperature detection section are disposed at positions, A, B and C in FIG. 7 or in other words at the position of the line of intersection of the chimney partition wall 50.

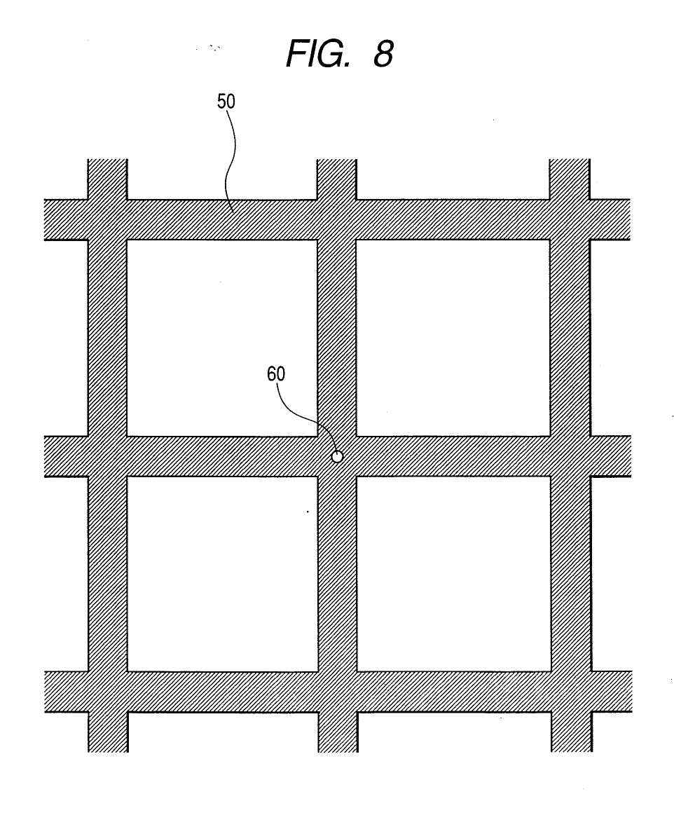

FIG. 8 shows an enlarged view of region X which is shown single-dot chain line in the chimney partition wall 50 of FIG. 7. The thermocouple extension wire pulling conduit 60 is disposed at the position of intersection where the chimney partition wall 50 crosses.

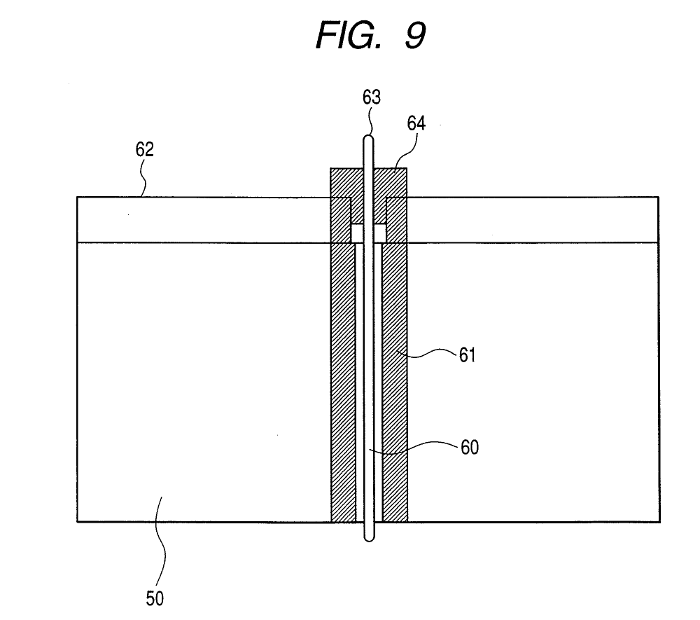

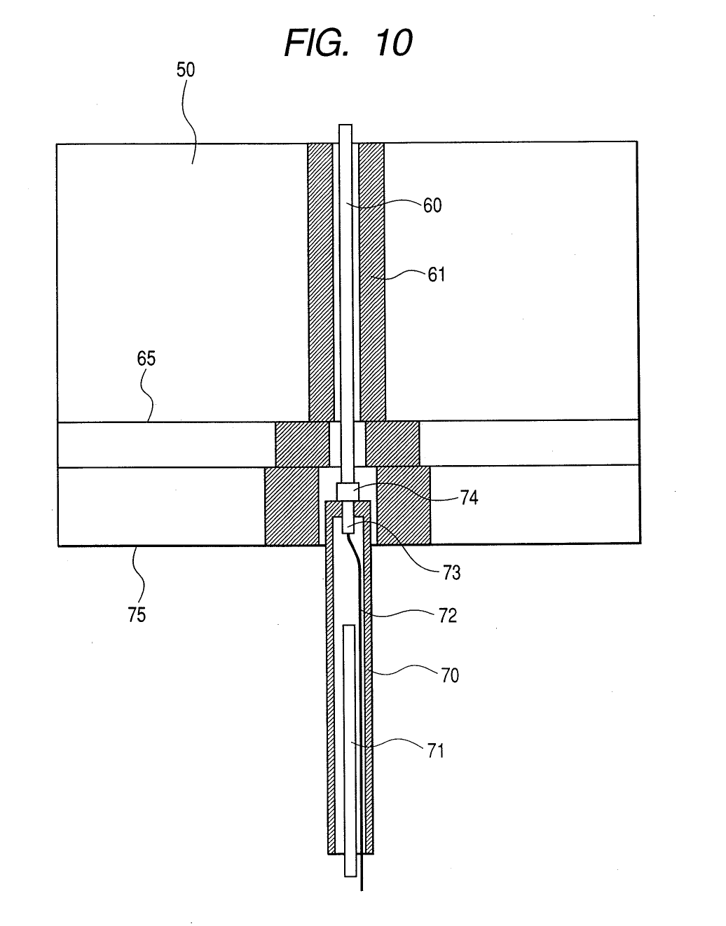

The placement of the thermocouple extension wire pulling conduit 60 and the method for retrieving the signal will be described based on FIG. 9 and FIG. 10.

FIG. 9 shows a longitudinal section of the intersection portion of the chimney partition in which the thermocouple extension wire pulling conduits 60 are disposed. As shown in FIG. 9, the thermocouple (not shown) which is the temperature detection section 63 is disposed at a position that projects slightly from the support bracket 62 of the chimney upper portion. This temperature detection section 63 is disposed at the front end portion of the upper portion of the thermocouple extension wire pulling conduit 60, and the thermocouple extension wire pulling conduit 60 is fixed to the chimney upper portion support plate 62 by a support bracket 64. As described hereinafter, the portion that is positioned at the chimney lower portion of the thermocouple extension wire pulling conduit 60 is joined to the neutron counter assembly 70 (see FIG. 10) arranged in the core 4.

Generally, in the natural circulation reactor, as shown in FIG. 1, the cylindrical core shroud 5 is disposed beneath the cylindrical chimney 9, and the core 4 is placed in the core shroud 5. The neutron instrumentation pipe assembly 70 is also disposed inside the core 4. The neutron instrumentation pipe assembly 70 is disposed vertically below the intersection line of the chimney partition wall 50 and measures the neutron flux in the core 4. As shown in FIG. 10, the thermocouple extension wire pulling conduit 60 passes through the penetration hole formed in the support plate 65 of the chimney lower portion, and is inserted into the penetration hole provided in the core upper plate 75. The core upper plate 75, which is aligned with the chimney lower support plate 65 each other, is connected with the core shroud 5 and the chimney 9. A connector 73 is united to the lowest portion of the thermocouple extension wire pulling conduit, and is joined to the highest portion of the neutron instrumentation pipe assembly 70. This joint may be performed, for example, by forming a male screw at the lower portion of the thermocouple extension wire pulling conduit 60 and screwing this male screw into the female screw formed on the neutron instrumentation pipe assembly 70. At this time, a pressure of about 70 atmospheric pressures is being applied in the chimney while inside the neutron instrumentation pipe assembly 70 has one atmospheric pressure as well as the outside of the reactor pressure vessel 6 (FIG. 1). The lower end portion of the thermocouple extension wire pulling conduit 60 provides with a sealing gland 74 so that the difference in pressure will be retained, performing the pressure sealing function.

The neutron instrumentation pipe assembly 70 shown in FIG. 10 is disposed at the center of four adjacent control rods inserted in the core 4, and neutron instrumentation pipe assemblies 70 is disposed such that there is one for 16 intersection positions of the lattice-like control rods. That is to say, the number of neutron instrumentation pipe assemblies 70 provided is 1/16 of the total number of control rods. A LPRM (Local Power Range Monitor) instrumentation pipe 71 is disposed in the neutron instrumentation pipe assembly 70. The cables 72 connected to the lower connector 73 of the thermocouple extension wire pulling conduit 60 are arranged along with the LPRM instrumentation pipe 71. The LPRM instrumentation pipe 71 and the cable 72 are pulled to the outside of the reactor pressure vessel 6 and connected to a monitor device that is not shown.

According to the second embodiment shown in FIG. 7-FIG. 10, because the thermocouple extension wire pulling conduit 60 is installed at the intersection position of the chimney partition wall 50 and the thermocouple cable in the thermocouple extension wire pulling conduit 60 is joined to the cable in the neutron instrumentation pipe assembly 70 which is at the vertical lower portion thereof, there is no need to prepare a new extension wire pulling conduit and extension wire pulling conduit port. The signals from the thermocouple for temperature detection can be transmitted to the monitor device by utilizing the neutron instrumentation pipe assembly 70 used to control the reactor power in the natural circulation reactor.

The method to form the insertion hole of the thermocouple extension wire pulling conduit 60 shown in FIG. 9 at the cross-section position of the chimney partition wall 50 may be carried out by forming the required corner in the chimney partition in advance such that a suitable space is formed when the chimney 9 is being assembled.

According to this example, the support bracket 64 can be detached without detaching the chimney and the thermocouple and the thermocouple extension wire pulling conduit 60 which form the temperature detection section 63 can be replaced.

It is to be noted that unlike the coolant temperature for which distribution in the radial direction occurs due to difference in thermal power of the fuel assembly, the pressure distribution in the radial direction at the same height in the chimney 9 is small, therefore the pressure inside of the chimney 9 can be measured by installing the detection section for the pressure conduit at an outer peripheral wall of the chimney 9 which contacts the downcomer 7. An example of measurement methods is to introduce the coolant from the upper portion of the chimney 9 to the pressure gauge through the hole formed in the reactor pressure vessel 6. Another example of measurement methods is connecting the chimney upper portion and the steam dome with a differential conduit and connecting a differential pressure gauge to the differential conduit and then measuring the pressure difference between the steam dome pressure which measures the absolute pressure. As is the case with the thermocouple extension wire pulling conduit which measures temperature, a differential conduit can be disposed on the upper portion of the chimney 9 to measure the pressure of the upper portion. In this case, the thermocouple extension wire pulling conduit 60 and the differential conduit may be stored in a common thermocouple extension wire pulling conduit assembly 55.

Embodiments of the present invention were described above, the present invention is not to be limited by the examples of the embodiments above and various other embodiments may be included in the present invention without departing from the spirit of the present invention described in the scope of the claims.

What is claimed is:

1. A natural circulation boiling water reactor, comprising:
a reactor pressure vessel;
a chimney including a lattice member and arranged above a core in said reactor pressure vessel; and
at least one thermocouple extension wire pulling conduit into which a temperature detection thermocouple and a cable connected to said temperature detection thermocouple are inserted;
wherein said thermocouple extension wire pulling conduit is disposed on an upper end surface of said lattice member and mounted to said upper end surface of said lattice member.

2. The natural circulation boiling water reactor according to claim 1, wherein said thermocouple extension wire pulling conduit is mounted to said upper end surface of said lattice member by a support member.

3. The natural circulation boiling water reactor according to claim 1, wherein a front end of said thermocouple extension wire pulling conduit is disposed at a position adjacent to a side wall of said lattice member.

4. The natural circulation boiling water reactor according to claim 3, wherein a front end of said thermocouple extension wire pulling conduit is disposed at a vicinity of a crossing position of said lattice member.

5. A natural circulation boiling water reactor, comprising:
a reactor pressure vessel;
a chimney including a lattice member and arranged above a core in said reactor pressure vessel; and
at least one thermocouple extension wire pulling conduit into which a temperature detection thermocouple and a cable connected to said temperature detection thermocouple are inserted;
wherein said thermocouple extension wire pulling conduit is disposed on an intersection line of said lattice member so that said temperature detection thermocouple is disposed at a position on said intersection line.

6. The natural circulation boiling water reactor according to claim 5, wherein said thermocouple extension wire pulling conduit is disposed at a position above a neutron instrumentation pipe assembly arranged in said core.

7. The natural circulation boiling water reactor according to claim 6, wherein said thermocouple extension wire pulling conduit is connected to said neutron instrumentation pipe assembly at a core upper plate provided with a core shroud surrounding said core in said reactor pressure vessel.

8. The natural circulation boiling water reactor according to claim 7, wherein said cable connected to said temperature detection thermocouple is arranged in said neutron instrumentation pipe assembly.

9. The natural circulation boil water reactor according to claim 7, wherein a gap formed between said thermocouple extension wire pulling conduit and the neutron instrumentation pipe assembly is sealed by a sealing member.

10. The natural circulation boiling water reactor according to claim 7, wherein no greater than a same number of said thermocouple extension wire pulling conduits as a number of said neutron instrumentation pipe assemblies are disposed under at least one crossing position of said lattice member.
